(19) United States
(12) Patent Application Publication
(10) Pub. No.: US 2014/0154597 A1
(43) Pub. Date: Jun. 5, 2014

(54) Fuel Cells Based on Precise Energy Separation

(71) Applicant: Fahs Stagemyer LLC, Woodstock, CT (US)

(72) Inventor: Richard W. Fahs, II, Woodstock, CT (US)

(73) Assignee: Fahs Stagemyer LLC, Woodstock, CT (US)

(21) Appl. No.: 14/097,023

(22) Filed: Dec. 4, 2013

Related U.S. Application Data
(60) Provisional application No. 61/733,226, filed on Dec. 4, 2012.

(51) Int. Cl. H01M 8/06; H01M 8/10

(52) U.S. Cl. CPC H01M 8/06; H01M 8/10
USPC 429/422; 429/423

(57) ABSTRACT

Anodes utilizing precise energy separation are provided. The anodes can be used to generate electrical energy from a feedstock via precise energy separation. The anodes include an energy source that supplies the promoter energy to target molecules in a feedstock to dissociate one or more target bonds in one or more target molecules. Generally, the energy is provided in an effective amount, intensity, and frequency of energy to specifically dissociate one or more target bonds in one or more target molecule present in the feedstock, releasing electrons. These electrons are accepted by an electrode that is electrically connected to an electron sink. Fuel cells containing anodes utilizing precise energy separation are provided.

### CROSS-REFERENCE TO RELATED APPLICATIONS

This application claims priority to and benefit of U.S. Provisional Application No. 61/733,226, filed Dec. 4, 2012.

### FIELD OF THE INVENTION

The present invention is related to anodes based on precise energy separation, as well as methods of making the anodes and using the anodes, for example, in fuel cells, to generate energy.

### BACKGROUND OF THE INVENTION

Fuel cells and photovoltaic devices are attractive alternatives to conventional means of providing electrical energy. Specifically, fuel cells and photovoltaic devices have the potential to provide electrical energy without consuming non-renewable resources (e.g., fossil fuels) and generating substantial pollutants, including greenhouse gases.

In their simplest form, fuel cells are electrochemical conversion devices which convert a chemical fuel to electrical energy. Fuel cells are similar in design to batteries; however, unlike batteries, they are typically designed for continuous replenishment of the reactants consumed during fuel cell operation. As a consequence, fuel cells generally produce a continuous supply of electricity from chemical fuel provided externally, as opposed to providing a limited amount of electricity from a limited internal supply of stored reactants.

Fuel cells can be used to generate electrical power without producing pollutants and without consuming non-renewable hydrocarbon-based fuels, such as oil or gasoline. However, fuel cells can be hampered by several drawbacks. These drawbacks may decrease the realized performance or lifetime of the fuel cell, may increase the costs required, or both.

Fuel cell designs typically require very specific feed stock materials and purities. For instance, some fuel cells employ hydrogen gas as a chemical fuel. Hydrogen gas is difficult to store and transport to the anode surface. In addition, hydrogen cannot be produced in an economical fashion without the presence of impurities, such as carbon monoxide. These impurities can poison catalysts in the fuel cell, diminishing fuel cell performance over time. There is a need for fuel cells that are less sensitive to impurities in the feedstock material or are robust against catalyst poisoning.

Many fuel cells also employ catalysts at the anode that are too expensive, thereby limiting their usefulness in many cost-sensitive applications. In order to be suited for use in a wider range of applications, fuel cells which can generate electricity from economical and convenient chemical fuels with improved efficiency are required.

Therefore, it is an object of the invention to provide fuel cells that can operate with improved efficiency.

It is a further object of the invention to provide fuel cells that exhibit longer operational lifetimes.

It is a further object of the invention to provide fuel cells that can operate using a variety of feedstock materials, including waste materials, byproducts, and renewable materials, which are more cost effective.

It is also an object of the invention to provide fuel cells which can efficiently generate electrical energy without the use of an expensive catalyst material.

### SUMMARY OF THE INVENTION

Anodes utilizing precise energy separation are provided. The anodes include a container suitable to hold a volume of feedstock, one or more fluid inlets, one or more fluid outlets, an energy source, and an electrode electrically connected to an electron sink. The anodes can be used to generate electrical energy from a feedstock via precise energy separation.

The anodes include a container of suitable dimensions and integrity to hold a volume of feedstock. One or more fluid inlets and one or more fluid outlets are fluidly connected to the container to deliver feedstock to the container, and to remove feedstock and/or component products from the container. The feedstock may contain a variety of target molecules including pollutants, industrial waste products, reaction byproducts, metals, graphene doped materials, carbon based materials, and waste material.

The anodes include an energy source that supplies the promoter energy to the feedstock to dissociate one or more target bonds in one or more target molecules. The energy source may be positioned outside of the container (i.e., an external energy source) or integrated within the container; however, it must be positioned to transfer the energy to target molecules in the feedstock. Suitable energy sources include frequency generators, electrical generators, plasma generators, arc lamps, low energy nuclear reactions (LENR), LEED, an elliptically polarized light source which may include a light source in combination with a polarization filter, ionization chambers, photoionization detectors (PID), pulse generators, amplifying generators, tunable lasers, ultraviolet lamps, ultraviolet lasers, pulse ultraviolet generators, combination lasers or pulsed energy sources, ultrasound generators, pulsed lasers, diodes, natural light, infrared radiation, X-rays, Gamma rays, ultraviolet radiation, high harmonic generators or tunable high harmonic sources, and combinations thereof, alone or in combination with a catalyst or specialized catalyst such as an electron hopping material. In certain embodiments, the energy source is a fiber optic device, optionally coated with a catalyst such as graphene, present within the container.

Where applicable, the energy source may be optionally combined with other devices, such as amplifiers or filters. Generally, the energy source is connected to a control unit, which can regulate the energy source in order to provide an effective amount, intensity, and frequency of energy to specifically dissociate one or more target bonds in one or more target molecule present in the feedstock.

The anodes include an electrode. Electrodes are fabricated from a conductive material that can accept electrons released by precise energy separation. The electrodes are electrically connected to an electron sink or an electron storage material or unit using means to efficiently transfer electrons from the electrode to the electron sink. The electrode is electrically connected to an electron sink. The electron sink has an appropriate potential to cause electrons accepted by the electrode to flow to the electron sink and be stored or used directly to an electrical end source

Another example of an electron sink is a modified Photo Ionization Detector (PID), a portable vapor and gas detector that detects a variety of organic compounds. Photo ionization occurs when an atom or molecule absorbs light of sufficient energy to cause an electron to leave and create a positive ion.

The PID includes an ultraviolet lamp that emits photons that are absorbed by the compound in an ionization chamber. Ions (atoms or molecules that have gained or lost electrons and thus have a net positive or negative charge) produced during this process are collected by electrodes. The current generated provides a measure of the analyte concentration. Because only a small fraction of the analyte molecules are actually ionized, this method is considered nondestructive, allowing it to be used in conjunction with another detector to confirm analytical results. High intensities are used to move the process to a 100% completion. In addition, PIDs are available in portable hand-held models and in a number of lamp configurations. Results are almost immediate. A PID or Raman spectrometer can detect the target molecule and then via a computer software program, such as the “CANARY” program or similar program, the information can be transmitted to the high intensity PES unit which can react similar to the PID unit and ionize the molecule and create electricity. If desired, one or more catalysts may also be present within the anode.

The catalyst may be dissolved or dispersed within the feedstock, or supported on a surface within the anode. In some embodiments, the catalyst is deposited on a mesh within the container, on the surface of the electrode, or combinations thereof. In a particular embodiment, a catalyst is applied to the surface of a fiber optic device integrated with the electrode, and activated by energy (i.e., the specific energy of dissociation) from within the fiber optic device.

Suitable catalysts include titanium oxides (TiO₂), platinized titania, amorphous manganese oxide, copper-doped manganese oxide, single carbon chains, tubes, flakes or layers, titanium dioxide, strontium titanate, barium titanate, sodium titanate, cadmium sulfide, zirconium dioxide, iron oxide, carbon-based graphene or graphite, fullerenes, buckyballs, nanocrystalline diamond or similar carbon allotropes, a Nano-scale hybrid thereof, carbon-doped semi-conductive materials, carbon-doped magnetic materials, graphene oxides, nickel, nickel molybdenum and nickel molybdenum nitride, boron nitride, semiconductor materials including platinum, palladium, rhodium, and ruthenium, strontium titanate, amorphous silicon, hydrogenated amorphous silicon, nitrogenated amorphous silicon, polycrystalline silicon, germanium, catalysts made of cobalt (Co), nickel (Ni) and iron (Fe) elements, titanium disilicide, indium tin oxide (ITO) anode, poly(3,4-ethylenedioxythiophene) and combinations thereof. Additional catalysts include nickel-hydrogen (NiH₂ or Ni—H₂), Au—TiO₂, CdS, NaTaO₃, K₃Ta₃B₂O₁₂, Ga_{0.82}Zn_{0.18})(N_{0.82}O_{0.18}), and Pt/TiO₂. Photocatalysts based on cobalt can also be used. Members are tris(bipyridine) cobalt(II), compounds of cobalt ligated to certain cyclic polyamines, certain cobaloximes, and cobalt(II)-hydride.

Sensors may optionally be incorporated into the anodes to measure fluid flow rate, feedstock makeup or properties (e.g., turbidity, viscosity, or flow rate), the concentration of target molecules, the concentration of component products, current flow from the electrode, and combinations thereof. If desired, the sensors can be connected to a signal processing unit, such as a computer, which can monitor signal outputs, and send signals to anode components to influence precise energy separation at the anode. For example, the signal processing unit can send signals to the valves to control feedstock flow. The signal processing unit can send signals to the control unit to regulate the energy source.

Fuel cells containing anodes utilizing precise energy separation are provided.

### BRIEF DESCRIPTION OF THE DRAWINGS

FIG. 1 is a schematic diagram illustrating the components of an anode utilizing precise energy separation which utilizes an external energy source.

FIG. 2 is a schematic diagram illustrating the components of an anode utilizing precise energy separation which uses an energy source integrated within the container.

FIG. 3 is a schematic diagram illustrating the components of an anode utilizing precise energy separation containing multiple fluid inlets.

FIG. 4 is a schematic diagram illustrating the components of an anode utilizing precise energy separation containing multiple fluid outlets and sensors.

### DETAILED DESCRIPTION OF THE INVENTION

### I. Definitions and Mechanisms

“Irradiation” as generally used herein refers to subjecting or treating a sample with beams of particles, photons, or energy. Irradiation includes any form of electromagnetic or acoustic radiation.

“Bond dissociation energy” as generally used herein refers to the standard enthalpy of change when a bond is cleaved.

“Bond energy” as generally used herein refers to the average of the sum of the bond dissociation energies in a molecule.

“Component products” as generally used herein refers to known ions or atoms composed of only elements found within the target molecule. Individual component products have a chemical formula distinct from the target molecule. An example is N₂ and H₂, which are each component products of NH₃.

“Catalyst” as generally used herein refers to any chemical which enhances the rate and/or efficiency of molecular dissociation compared with the rate and/or efficiency of dissociation in the absence of the catalyst.

“Chemical waste” as generally used herein refers to any inorganic, organometallic, or organic substance, present in any physical state, that is unwanted in a given sample due to environmental or toxicity concerns.

“Dissociation” as generally used herein refers to the breaking of one or more of the bonds of a molecule. Dissociation in the current process requires that the original bonds of the target molecule do not re-associate.

“Excited state” as generally used herein refers to a state in which one or more electrons of an atom or molecule are in a higher-energy level than ground state.

“Non-target molecule” as generally used herein refers to the any substance within a sample containing target molecules which is not affected by the process.

“Promoter” as generally used herein refers to the energy required for dissociation of a target bond, which is both selective for the target bond and sufficient to prevent re-association of the bond.

“Energy of dissociation source” as generally used herein refers to any chemical, apparatus, or combination thereof, which supplies the energy of dissociation with the energy required to dissociate target bonds within a target molecule. The energy of dissociation source must supply suitable intensity and suitable frequency for target bond dissociation. An example of an energy of dissociation source is an xenon lamp coupled to a pulse generator. An energy of dissociation source can optionally contain a catalyst. An example of such an energy of dissociation source is a titanium dioxide catalyst and an xenon lamp coupled to a pulse generator.

“Recycling” as generally used herein refers to reusing substances found in waste for any purpose.

“Remediation,” as used herein, refers to treatment of waste to capture stored energy or useful components trapped therein.

“Target molecule,” as used herein, refers to a molecule, or portion of a macromolecule, that contains at least one bond, which is subjected to precise energy dissociation. A target molecule can also be a nanoparticle, microparticle, cell, virus, or portion thereof.

“Feedstock,” as used herein, refers to at least one target molecule which is subjected to the dissociation process. The feedstock may include exclusively target molecules. Alternatively, the feedstock may be a complex mixture which includes both target and non-target molecules.

“Target bond,” as used herein, refers to any bond within a target molecule. Target bonds can be covalent, ionic, or “weak bonds” including dipole-dipole interactions, London dispersion forces, or hydrogen bonding. Target bonds can be single or multiple covalent bonds.

“Electron Sink,” as used herein, refers to any means or material which can collect, store or transfer free electrons to a storage or end use device such as an electrical capacitor or battery.

A. Mechanisms Related to Precise Energy Dissociation

An atom is ionized by absorbing a photon of energy equal to or higher than the ionization energy of the atom. Multiple photons below the ionization threshold of an atom may combine their energies to ionize an atom by a process known as multi-photon ionization. These concepts also apply to molecules. Resonance enhanced multi-photon ionization (REMPI) is a technique in which a molecule is subjected to a single resonant or multi-photon frequency such that an electronically excited intermediate state is reached. A second photon or multi-photon then ejects the electronically excited electron and ionizes the molecule.

Among a mixture of molecules with different bond dissociation energies, selective activation of one chemical bond requires a mono-chromatic source. For example, in a compound containing N—H (bond dissociation energy of 3.9 eV) and C—H (bond dissociation energy of 4.3 eV) bonds, a specific photon source of 4.0 eV dissociates the N—H bond exclusively.

Precise energy separation relies on two main principles. The first principle is that the selective dissociation of one or more target bonds in a target molecule can be achieved by irradiating the target molecule with the specific energy (both frequency and intensity) required to selectively dissociate one or more target bonds and to prevent re-association of the target bond (i.e, the promoter energy). By exciting a target molecule with the precise energy required to dissociate one or more target bonds in a target molecule, one or more target bonds can be selectively cleaved, releasing electrons. Because the target molecule is treated with energy specific to dissociate one or more target bonds in a target molecule, a target molecule can be selectively dissociated in a complex mixture. The second principle is that the dissociation of target molecules can involve the dissociation of one or more target bonds. These bonds can be individually dissociated by irradiating the target molecule by a plurality of photons or other energetic sources which provide the promoter energy for each bond to be dissociated.

Given this control, target molecules can be treated using precise energy separation to separate the target molecules into their component products without producing any by-products and without re-association of the one or more target bonds. In certain embodiments treating target molecules using precise energy separation results in less than 20% re-association of the one or more target bonds, less than 10% re-association of the one or more target bonds, less than 9% re-association of the one or more target bonds, less than 8% re-association of the one or more target bonds, less than 7% re-association of the one or more target bonds, less than 6% re-association of the one or more target bonds, less than 5% re-association of the one or more target bonds, less than 4% re-association of the one or more target bonds, less than 3% re-association of the one or more target bonds, less than 2% re-association of the one or more target bonds, less than 1% re-association of the one or more target bonds. In certain embodiments treating target molecules using precise energy separation results in no or an undetectable amount of re-association of the one or more target bonds. One skilled in the art will recognize that the term by-products will depend upon the specific target molecules in the feedstock and the target bonds to be dissociated. In some embodiments the by-product can be understood to mean anything other than the components formed from the dissociation of the one or more target bonds. In certain embodiments the components formed from the dissociation of the one or more target bonds may be transient species. The transient species may optionally react to form other component products without re-association of the one or more target bonds.

### II. Anodes Utilizing Precise Energy Separation

Anodes utilizing precise energy separation include a container suitable to hold a volume of feedstock, one or more fluid inlets, one or more fluid outlets, an energy source, and an electrode electrically connected to an electron sink. The anodes can be used to generate electrical energy from a feedstock via precise energy separation.

The anodes include a container of suitable dimensions and integrity to hold a volume of feedstock. The container may be fabricated from any suitable material, including metals, polymers, ceramics, and combinations thereof.

One or more fluid inlets and one or more fluid outlets are fluidly connected to the container to deliver feedstock to the container, and to remove feedstock and/or component products from the container. The number and position of fluid outlets and fluid inlets can be varied in view of the feedstock chosen, desired flow dynamics (e.g., flow rate of the feedstock through the anode), the identity of component products formed by precise energy separation, and combinations thereof. Valves may be incorporated into the fluid inlets and fluid outlets, as required, to control flow of the feedstock through the anode.

In certain embodiments, membranes with selective permeability may be incorporated within one or more of the fluid outlets to purify component products. Membranes with selective permeability may be incorporated within one or more of the fluid outlets to select appropriate component products which may flow via a fluid outlet to a cathode where they are oxidized in a corresponding reduction half-cell reaction.

In certain embodiments, the anode incorporates interfaces that promote electron hopping. In some embodiments a graphene interface promotes electron hopping. In some instances the graphene interface is a reduced form of graphene or a graphene oxide. In some embodiments the anode incorporates multi-layered materials consisting of graphene oxide and titanium oxide layers, optionally with a silver layer that will facilitate electron hopping. In some embodiments the interface that promotes electron hopping is formed from one or a few layers of common electrode materials, including but not limited to metals or metal oxides such as indium-tin-oxide.

In certain embodiments, the anode incorporates interfaces and optionally catalysts that selectively split water into hydrogen and oxygen. In some embodiments this is accomplished in anodes incorporating semiconductor nanoparticles and metal catalysts separated optionally by a layer of graphene or other suitable carbon allotrope. In some embodiments the nanoparticles are metal or metal-oxide nanoparticles, including but not limited to exemplary nanoparticles of indium-tin-oxide, cadmium selenide, zinc-oxide nanoparticles, or silver.

In certain embodiments, the anode container may also enclose the cathode. The anode and cathode regions may optionally be separated by a barrier. In some embodiments the barrier is a permeable or semi-permeable membrane. In some embodiments, the barrier is a proton exchange membrane. The proton exchange membrane may be a solid or semi-solid polymer membrane. Exemplary materials for proton exchange membranes include sulfonated tetrafluoroethylene based polymers such as those marketed under the trade names NAFLON® by Dupont or the sulfonated polystyrene copolymers marketed under the trade name ULTREX® by Membranes International. In some embodiments the barrier consists of a ceramic matrix. The ceramic matrix may optionally be an oxide material. In certain embodiments, the membrane facilitates the flow of cationic species from the anode region to the cathode region. In certain embodiments, the anode and cathode regions are connected by a wire or length of material that facilitates the flow of cationic species from the anode region to the cathode region. In certain embodiments this connection is a nanowire having a diameter less than 2 μm, preferably less than 1 μm, more preferably less than 500 nm, most preferably less than 100 nm. In certain embodiments the nanowire is made of NAFLON®.

The anodes include an energy source that supplies the promoter energy to the feedstock to dissociate one or more target bonds in one or more target molecules. The energy source may be positioned outside of the container (i.e., an external energy source) or integrated within the container; however, it must be positioned to transfer the energy to target molecules in the feedstock. In certain embodiments, the energy source is a fiber optic device, optionally coated with a catalyst such as graphene or a photocatalyst, present within the container. Generally, the energy source is connected to a control unit, which can regulate the energy source in order to provide an effective amount, intensity, and frequency of energy to specifically dissociate one or more target bonds in one or more target molecules present in the feedstock.

The anodes also include an electrode. Electrodes are fabricated from a conductive material that can accept electrons released by precise energy separation. The electrodes are electrically connected to an electron sink using suitable means to efficiently transfer electrons from the electrode to the electron sink. The electron sink has an appropriate potential to cause electrons accepted by the electrode to flow to the electron sink. In certain embodiments the electrode material is a metal such a copper, titanium, silver, platinum, or palladium or a metal oxide such as zinc-oxide, copper-oxide, or indium-tin-oxide.

If desired, one or more catalysts may also be present within the anode. The catalyst may by dissolved or dispersed within the feedstock, or supported on a surface within the anode. In some embodiments, the catalyst is deposited on a mesh within the container, on the surface of the electrode, or combinations thereof. In a particular embodiment, a catalyst is applied to the surface of a fiber optic device integrated with the electrode, and activated by energy (i.e., the specific energy of dissociation) from within the fiber optic device.

Sensors may optionally be incorporated into the anodes to measure fluid flow rate, feedstock makeup or properties (e.g., turbidity, viscosity, or flow rate), the concentration of target molecules, the concentration of component products, current flow from the electrode, or combinations thereof. If desired, the sensors can be connected to a signal processing unit, such as a computer, which can monitor signal outputs, and send signals to anode components to influence precise energy separation at the anode. For example, the signal processing unit can send signals to the valves to control feedstock flow. The signal processing unit can send signals to the control unit to regulate the energy source.

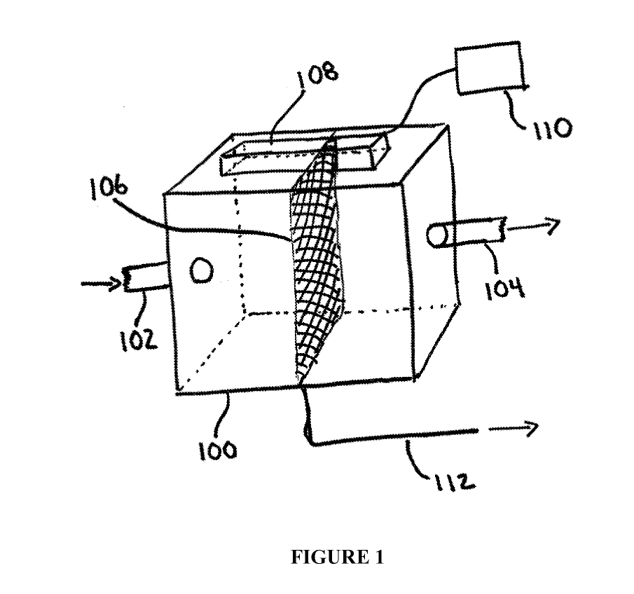

FIG. 1 illustrates a representative anode utilizing precise energy separation. The anode includes a container (100) suitable to hold a volume of feedstock, and a fluid inlet (102) and a fluid outlet (104) for delivering feedstock to and from the container. An electrode (106) is present within the container, preferably of appropriate dimensions to facilitate contact with the feedstock. For example, the electrode can be positioned to traverse a fluid flow path between the fluid inlet and the fluid outlet. The electrode is electrically connected to an electron sink (112) using suitable means to efficiently transfer electrons from the electrode to the electron sink. One or more energy sources (108) are positioned to transfer the energy to target molecules in the feedstock. In this case, the energy source is positioned to traverse the length of the container. The energy source may be connected to a control unit (110) which can control the energy source to provide an effective amount, intensity, and frequency of energy to specifically dissociate one or more target bonds in one or more target molecule present in the feedstock. If desired, a catalyst may be present within the anode. The catalyst may be dissolved or dispersed within the feedstock, or supported on a surface within the anode. For example, a catalyst may be deposited on the surface of the electrode, on one or more surfaces of the container, or combinations thereof.

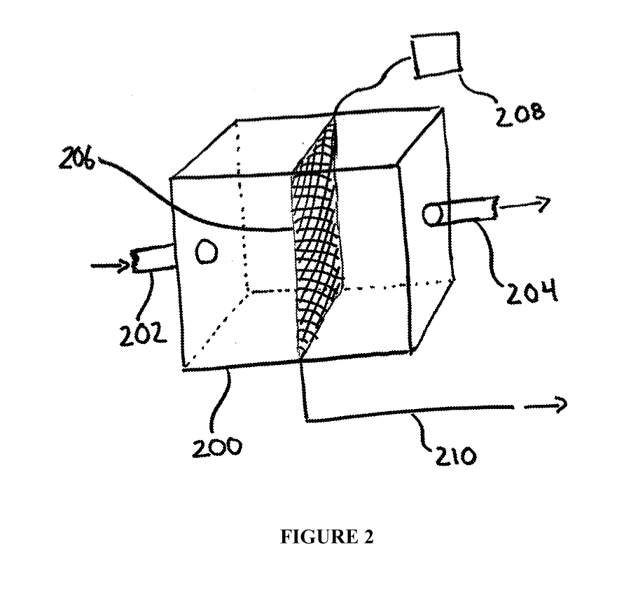

FIG. 2 illustrates another anode utilizing precise energy separation. The anode includes a container (200) suitable to hold a volume of feedstock, and a fluid inlet (202) and fluid outlet (204) for delivering feedstock to and from the container. An electrode (206) is present within the container, preferably of appropriate dimensions to facilitate contact with the feedstock. For example, the electrode can be positioned to traverse a fluid flow path between the fluid inlet and the fluid outlet. The electrode is electrically connected to an electron sink (210) using suitable means to efficiently transfer electrons from the anode to the electron sink. One or more energy sources (206) are integrated within the container, in this case within the electrode. This can be accomplished, for example, by employing an electrode with an integrated fiber optic device to transmit energy to one or more target molecule present in the feedstock. The energy source may be connected to a control unit (208) which can control the energy source in order to provide an effective amount, intensity, and frequency of energy to specifically dissociate one or more target bonds in one or more target molecule present in the feedstock. If desired, a catalyst may be present within the anode. The catalyst may by dissolved or dispersed within the feedstock, or supported on a surface within the anode. In a particular embodiment, a catalyst is applied to the surface of a fiber optic device integrated with the electrode, and activated from the inside by the specific energy of dissociation.

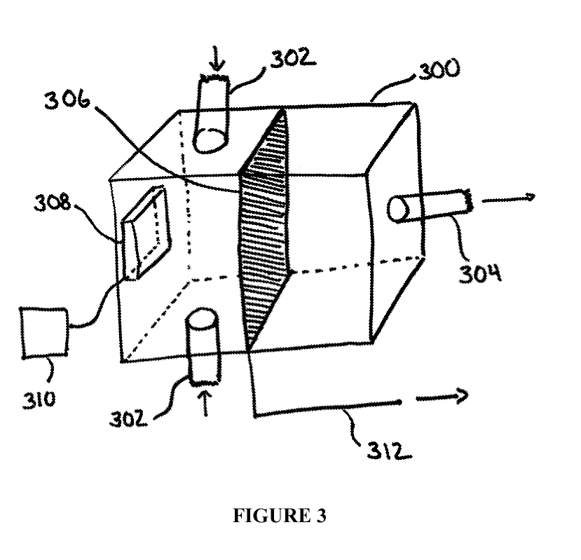

FIG. 3 illustrates another anode utilizing precise energy separation. The anode includes a container (300) suitable to hold a volume of feedstock, and two fluid inlets (302) and a fluid outlet (304) for delivering feedstock to the container. An electrode (306) is present within the container, preferably of appropriate dimensions to facilitate contact with the feedstock. For example, the electrode can be positioned to traverse a fluid flow path between the fluid inlets and the fluid outlet. The electrode is electrically connected to an electron sink (312) using suitable means to efficiently transfer electrons from the electrode to the electron sink. One or more energy sources (308) are positioned to transfer the energy to target molecules in the feedstock. In this case, the energy source is positioned in proximity to the fluid inlets. The energy source may be connected to a control unit (310) which can control the energy source in order to provide an effective amount, intensity, and frequency of energy to specifically dissociate one or more target bonds in one or more target molecule present in the feedstock. If desired a catalyst may be present within the anode. The catalyst may by dissolved or dispersed within the feedstock, or supported on a surface within the anode. In a preferred embodiment, a suitable catalyst is deposited on the surface of the electrode. In this case, the distance between the energy source and the electrode may be varied to optimize the precise energy separation in the vicinity of the electrode in view of, for example, the turbidity of the feedstock introduced into the anode.

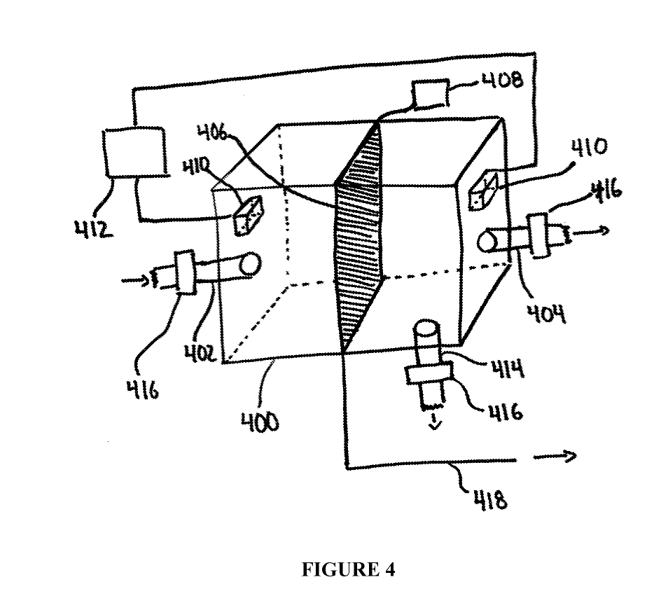

FIG. 4 illustrates another anode utilizing precise energy separation. The anode includes a container (400) suitable to hold a volume of feedstock, and a fluid inlet (402) and fluid outlet (404) for delivering feedstock to the container. The container can further contain a second fluid outlet (414) to collect or condense a component product formed during precise energy separation. Valves (416) can be integrated within the fluid inlet and the fluid outlet to control flow of the feedstock and/or component products into and out of the container. An electrode (406) is present within the container, preferably of appropriate dimensions to facilitate contact with the feedstock. For example, the electrode can be positioned to traverse a fluid flow path between the fluid inlet and the fluid outlet. The electrode is electrically connected to an electron sink (418) using suitable means to efficiently transfer electrons from the anode to the electron sink. One or more energy sources (406) are integrated within the container, in this case within the electrode. This can be accomplished, for example, by employing an electrode with an integrated fiber optic device to transmit energy to one or more target molecule present in the feedstock. The energy source may be connected to a control unit (408) which can control the energy source in order to provide an effective amount, intensity, and frequency of energy to specifically dissociate one or more target bonds in one or more target molecule present in the feedstock. If desired a catalyst may be present within the anode. The catalyst may by dissolved or dispersed within the feedstock, or supported on a surface within the anode. In a particular embodiment, a catalyst is applied to the surface of a fiber optic device integrated with the electrode, and activated from the inside by the specific energy of dissociation. Sensors (410) can be integrated into the anode to permit real-time monitoring of the anode's function. Preferably, the sensors are positioned to not obstruct fluid flow. The sensors can be connected to a signal processing unit (412), such as a computer, which can monitor signal outputs, and send signals to anode components to influence precise energy separation at the anode. For example, the signal processing unit can send signals to the valves to control feedstock flow. The signal processing unit can send signals to the control unit to regulate the energy source.

A. Feedstock

The feedstock for reduction at the anode contains one or more suitable target molecules. Target molecules must contain at least one bond to be dissociated. Target molecules can be any compound of the solid, liquid, gas, or plasma physical state. Target molecules can be charged or uncharged. Target molecules can be naturally occurring or semi-synthetically or synthetically prepared compounds.

In one embodiment, the target molecules are a purified material. An example is distilled water, which is dissociated into H₂ and O₂ by the process described herein. In another embodiment, the target molecules are in a mixture including non-target molecules, such as a solution containing one or more target molecules. An example is ammonia dissolved in water. In this embodiment, ammonia is the target molecule, and is dissociated into N₂ and H₂. Water in this embodiment is not dissociated because the energy of dissociation is specific for the energy required to dissociate the N—H bonds of ammonia and not the O—H bonds of water.

Precise energy dissociation can be used to dissociate one or more bonds in almost any molecule. As a consequence, almost any suitable molecule may serve as a target molecule. In general, suitable target molecules can be selected in view of the availability of target molecules, the nature of the dissociation process (including available sources of the promoter energy), and the suitability of component products. For example, the target molecule may be an organic molecule or an inorganic molecule.

In certain embodiments, the target molecule is an organic compound that can be obtained from a renewable source, such as a carbohydrate. Typically, carbohydrates are organic compounds formed exclusively from carbon, hydrogen, and oxygen, typically with the empirical formula Cₘ(H₂O)ₙ, wherein m and n are independently integers. The carbohydrates may be monosaccharides, disaccharides, oligosaccharides, or polysaccharides. The monosaccharides may be aldoses or ketoses, and may contain any number of carbon atoms (i.e., the monosaccharides may be trioses, tetroses, pentoses, hexoses, heptoses, etc.). Examples of suitable monosaccharides include dihydroxyacetone, glyceraldehyde, erythrulose, threose, erythrose, arabinose, ribose, xylose, ribulose, allose, altrose, mannose, glucose, galactose, sorbose, tagatose, and fructose. Suitable disaccharides include sucrose, lactulose, lactose, maltose, trehalose, and cellobiose. Examples of suitable oligosaccharides include fructo-oligosaccharides (FOS). Examples of suitable polysaccharides include starch, cellulose, inulin, glycogen, chitin, callose, laminarin, chrysolaminarin, xylan, arabinoxylan, mannan, fucoidan and galactomannan. The target molecule may also be an amino sugar, such as N-acetylglucosamine, galactosamine, or sialic acid.

In other cases, the target molecule is waste, a reaction byproduct, or a pollutant. Examples of suitable wastes, reaction byproducts, and pollutants include alkyl sulfonates, alkyl phenols, ammonia, benzoic acid, carbon monoxide, carbon dioxide, chlorofluorocarbons, dioxin, fumaric acid, grease, herbicides, hydrochloric acid, hydrogen cyanide, hydrogen sulfide, formaldehyde, methane, nitrogenous wastes (sewage, waste water, and agricultural runoff), nitric acid, nitrogen dioxide, ozone, pesticides, polychlorinated biphenyls (PCBs), oil, ozone, sulfur dioxide, and sulfuric acid. In some cases, the target molecules are reactive or volatile aliphatic or aromatic organic compounds.

Conventional fossil fuels, such as methane or conventional petroleum distillates, may also serve as target molecules.

1. Target Bonds

A target bond is any bond within a target molecule which is subjected to precise energy separation. Target bonds should possess a dissociation energy or energies which, if applied, will break the target bond, and not allow the bond to reform. Types of bonds that may be selectively dissociated using precise energy separation include covalent bonds, ionic bonds, as well as intermolecular associations such as hydrogen bonds. In some cases, the target molecule contains a single target bond. In other embodiments, the target molecule contains multiple target bonds.

In cases when the target bond is a covalent bond, the bond may be a single bond, double bond, or triple bond. A non-limiting list of exemplary target bonds include N—H, C—H, C—C, C═C, C≡C, C—N, C═N, C≡N, C—O, C═O, C≡O, O—H, O—P, O═P, and C—X bonds, where X is any halogen selected from chlorine, fluorine, iodine, and bromine.

Precise energy separation requires that the energy of dissociation must be specific for the target bond of the target molecule. Bond dissociation energies are well known in the art. Examples of bond dissociation energies include H—H, 104.2 kcal/mol; B—F, 150 kcal/mol; C═C, 146 kcal/mol; C—C, 83 kcal/mol; B—O, 125 kcal/mol; N═N, 109 kcal/mol; N—N, 38.4 kcal/mol; C—N, 73 kcal/mol; O═O, 119 kcal/mol; O—O, 35 kcal/mol; N—CO, 86 kcal/mol; C═N, 147 kcal/mol; F—F, 36.6 kcal/mol; C—O, 85.5 kcal/mol; C═O (CO2), 192 kcal/mol; Si—Si, 52 kcal/mol; O—CO, 110 kcal/mol; C═O (aldehyde), 177 kcal/mol; P—P, 50 kcal/mol; C—S, 65 kcal/mol; C═O (ketone), 178 kcal/mol; S—S, 54 kcal/mol; C—F, 116 kcal/mol; C═O (ester), 179 kcal/mol; Cl—Cl, 58 kcal/mol; C—C, 181 kcal/mol; C═O (amide), 179 kcal/mol; Br—Br, 46 kcal/mol; C—Br, 68 kcal/mol C═O (halide), 177 kcal/mol; I—I, 36 kcal/mol; C—I, 51 kcal/mol; C═S (CS2), 138 kcal/mol; H—C, 99 kcal/mol; C—B, 90 kcal/mol; N═O (HONO), 143 kcal/mol; H—N, 93 kcal/mol; C—Si, 76 kcal/mol; P═O (POCl₃), 110 kcal/mol; H—O, 111 kcal/mol; C—P, 70 kcal/mol; P═S (PSCl₃), 70 kcal/mol; H—F, 135 kcal/mol; N—O, 55 kcal/mol; S═O (SO₂), 128 kcal/mol, H—Cl, 103 kcal/mol; S—O, 87 kcal/mol; S═O (DMSO), 93 kcal/mol; H—Br, 87.5 kcal/mol; Si—F, 135 kcal/mol; P═P, 84 kcal/mol; H—I, 71 kcal/mol; Si—Cl, 90 kcal/mol; P≡P, 117 kcal/mol; H—B, 90 kcal/mol; Si—O, 110 kcal/mol; C≡O, 258 kcal/mol; H—S, 81 kcal/mol; P—Cl, 79 kcal/mol; C≡C, 200 kcal/mol; H—Si, 75 kcal/mol; P—Br, 65 kcal/mol; N≡N, 226 kcal/mol; H—P, 77 kcal/mol; P—O, 90 kcal/mol; C≡N, 213 kcal/mol.

In one embodiment, target bonds are dissociated heterolytically. When heterolytic cleavage occurs, ionic component products may be produced in addition to radicals and ejected electrons, for example:

A:B→A.+B⁺+e⁻ or A:B→A⁺+B.+e⁻

The radicals can re-associate to form A:B, but in preferred embodiments, the radicals re-associate in a homomeric fashion to form A:A and B:B component products. In some embodiments the component products may be understood to be the radicals, and optionally the radicals may be transient species that react to form other molecules or components without the re-association of the target bond. One, two, or more identical radicals can associate to form known ions, atoms, or molecules.

In some embodiments, the target molecules contain multiple non-identical atoms, multiple oxidation states, or combinations thereof, all of which contain a variety of types of target bonds. Examples of target molecules with non-identical target bonds containing multiple non-identical atoms are dichloroethane (CH₂Cl₂) and ethanolamine (HOCH₂CH₂NH₂). Examples of target molecules with non-identical target bonds with multiple oxidation states include ethyl acetylene HC≡CH₂CH₃ and ethyl isocyanate (CH₃CH₂N═C═O).

B. Energy Sources

The anodes also include an energy source which supplies the promoter energy to the feedstock to dissociate one or more target bonds in one or more target molecules. The energy source provides the energy of the promoter.

An energy source can supply the energy of dissociation in the form of electromagnetic energy, acoustic energy, or any other energy which meets the bond dissociation energy of the target bond. In some instances, the source energy is selected from a non-exclusive list including photonic, photo-catalytic, chemical, kinetic, potential, magnetic, thermal, sound, light, DC or AC modulation current (electrical), plasma, ultrasound, piezoelectric, electrochemical energy, or combinations thereof.

Suitable energy sources include any apparatus which can supply the specific bond dissociation energy to break target bonds of target molecules specifically without non-target molecule bonds being affected. Examples include mono-chromatic light, monotone sound, or any other mono-energy source. In certain embodiments, the energy source supplies the appropriate frequency and intensity of energy required to attain a multi-photon or multi-frequency energy of dissociation within a rapid time scale through use of a generator of nano to pico-pulse cycles.

In some embodiments, the energy source is a frequency generator, electrical generator, plasma generator, arc lamp, pulse generators, amplifying generator, tunable laser, ultraviolet lamp, ultraviolet laser, pulse ultraviolet generator, ultrasound generator, or combination thereof. In preferred embodiments, the energy source is a pulse tunable laser or diode attached to a pulse generator.

In some embodiments, the energy source is one or more reactor beds having any number of lamps, generators, and/or bulbs; lamps, generators, and/or bulbs having the same or different sizes in terms of diameter and length; lamps, generators, and/or bulbs having the same or different wattages and/or any combination of the foregoing. The lamps, generators, and/or bulbs useful in this method can be any shape, size, or wattage. For example, use of a pulse light source allows one to use a 10 watt input of energy and generate 400,000 watts of pulse energy within ⅓ of a second of output, thereby reducing energy usage and equipment size and cost.

Those skilled in the art will recognize the nature of the target bond and target molecule will determine the identity, frequency, and intensity of energy source. The identity, frequency, and intensity of energy source may also be dependent upon whether or not a catalyst is present within the fuel cell.

In one embodiment, photocatalytic processes use ultraviolet light promoters, supplied by ultraviolet energy sources that are positioned to emit photons of ultraviolet light. The ultraviolet light sources are generally adapted to produce light having one or more wavelengths within the ultraviolet portion of the electromagnetic spectrum. However, the method should be understood as including ultraviolet light sources that may produce other light having one or more wavelengths that are not within the ultraviolet portion (e.g., wavelengths greater than 400 nm) of the electromagnetic spectrum.

In other photocatalytic processes, the energy source is replaced by other devices, such as lamps or bulbs other than ultraviolet fluorescent lamps or bulbs; non-ultraviolet light emitting diodes; waveguides that increase surface areas and direct ultraviolet light and any energy light source that activates a photocatalyst; mercury vapor lamps; xenon lamps; halogen lamps; combination gas lamps; and microwave sources to provide sufficient energy to the photocatalyst substance to cause the bond dissociation to occur.

In one embodiment, the photocatalyst is applied to the surface of a fiber optic device and activated from the inside by the specific energy of dissociation. The fiber optic device can be placed into a membrane through which air, solids or liquids flows, or integrated within an electrode. In some embodiments, the fiber optic device is coated with a layer of a catalyst for precise energy separation, such as graphene. The catalyst can be excited, for example, by light traveling through the fiber optic device. If desired, the catalyst present on the fiber optic device can be coated with a protective coating.

Those skilled in the art will recognize that the energy source should be positioned to transfer the energy to the one or more target molecules. How and in what form the energy is transferred will depend upon the choice of the energy source, but the transfer will result in energy being supplied from the energy source into the target molecules sufficient to promote the dissociation of one or more target bonds, sufficient to promote the ejection of one or more electrons, or to promote both the dissociation of one or more target bonds and the ejection of one or more electrons. In preferred embodiment the energy source transfers energy to the target molecules by emitting the precise frequency and intensity of light or electromagnetic radiation that is subsequently absorbed by the target molecules to promote the dissociation of one or more target bonds, sufficient to promote the ejection of one or more electrons, or to promote both the dissociation of one or more target bonds and the ejection of one or more electrons.

1. Energy of Dissociation

The energy of dissociation is the energy required for the dissociation of one or more target bonds in a target molecule, and is specific for the target bond or bonds within a target molecule. The energy of dissociation is tunable and specific for the bond dissociation energy of any target bond within any target molecule. The energy of dissociation is applied at a frequency and intensity effective for both scission of the target bond and target molecule dissociation.

In an example, the target molecule is AB, and application of the energy of dissociation specific for the A—B bond results in ejection of an electron from the target bond, yielding a radical, an ion, and an electron, according to the following possible mechanisms:

A:B→A.+B⁺+e⁻ or A:B→A⁺+B.+e⁻

The ions and radicals can be stable isolable species, or can combine with other ions to form molecules, i.e., the component products. The ejected electrons can be captured by an electron sink via an electrode. The intensity of the energy of dissociation should be such that re-association of components back into the target molecules does not occur.

In one embodiment, application of the energy of dissociation satisfies the bond dissociation energy of the target bond of a target molecule via a one step electronic process, and the target bond is dissociated. Once one target bond has been dissociated, the energy of dissociation source can be tuned to the frequency of a second target bond dissociation energy and applied to the sample to affect dissociation of a second target bond. The energy of dissociation sources can be tuned as needed to dissociate all target bonds of the target molecule. There are numerous apparatuses that can provide multi-energy or photons within a nano second or quicker to effect irreversible dissociation and prevent formation of reactants from the dissociated target molecule components.

In another embodiment, application of the energy of dissociation satisfies the bond dissociation energy of the target bond of a target molecule via a process involving the Rydberg excited state of the target molecule. First, the energy of dissociation source excites the target molecule to a Rydberg state, wherein the energy required to nearly remove an electron from the ionic core (the ionization or dissociation energy) of a target molecule has been achieved. Next, the same or different energy of dissociation source then supplies sufficient energy to eject the excited electron from the target bond. In this embodiment, one or more energy of dissociation sources can be used for each step. Once one target bond has been dissociated, the energy of dissociation source can be tuned to the frequency of a second target bond dissociation energy. The energy of dissociation sources can be tuned as needed to dissociate all target bonds of the target molecule.

For example, treatment of ammonia with an energy of dissociation occurs via the two-step process involving the Rydberg State. First, energy of dissociation treatment of 193 nm excites a shared electron in the N—H bond such that ammonia is in an excited Rydberg state. Subsequent energy of dissociation treatment of 214 nm energy expels the electron and dissociates ammonia into NH₂⁺ and H. Subsequent dissociative processes will give component products which re-associate to form N₂ and H₂.

In one embodiment, the one-step process, the two-step process, or a combination thereof are used to dissociate the target molecule. In one embodiment, one or more energy of dissociation sources are used for dissociation of each target bond within a target molecule. In one embodiment, one or more energy of dissociation sources are used in combination for dissociation of each target bond within a target molecule.

An exemplary molecule contains N—H, C—O, and O—H bonds. The N—H bond is cleaved with application of a 193 nm and 214 nm xenon bulb energy of dissociation source. The C—O bonds are cleaved with a mono-chromatic pulse generator. The O—H bonds are cleaved with a combination of photocatalyst and UV radiation. All of these energy of dissociation sources comprise the energy of dissociation required for complete dissociation of all the bonds of the target molecule. In some cases this requires three or more bond energies to expel the electron. In some cases, a filter may be used to isolate wavelengths or energies from a wide range source.

2. Energy Source Intensity

Energy source intensity is the quantity of energy supplied to treats a target molecule. Energy source intensity is directly proportional to the number and percentage of bonds which can be dissociated. Low intensity energy sources have the capability to dissociate a smaller proportion of target bonds compared to a higher intensity energy sources. For example, in a photonic energy source, the greater the number of photons present, the higher the likelihood of ejecting electrons.

In one embodiment, energy source intensity is increased by use of a pulse generator in conjunction with a lamp of the proper wavelength, or a tunable laser. In a preferred embodiment, the pulse generator supplies a predetermined number of pulses per second.

3. Energy Source Frequency

The frequency of energy source (in photonic cases, the wavelengths of radiant energy) specifically dissociates target bonds of target compounds. One frequency, multiple selected frequencies, or combinations of energy source frequencies can be used depending on the chemical structure of the target material. The apparatus must deliver sufficient intensity of the dissociation energy to completely dissociate the bond in adequate numbers to satisfy the need of the end user.

Methods of determining the appropriate frequency at which a target bond can be dissociated is known in the art, and include resonance enhanced multi-photon ionization (REMPI) spectroscopy, resonance ionization spectroscopy (RIS), photofragment imaging, product imaging, velocity map imaging, three-dimensional ion imaging, centroiding, zero electron kinetic imaging (ZEKE), mass enhanced threshold ionization (MATI), and photo-induced Rydberg ionization (PIRI).

Wavelengths to dissociate hydrogen atoms from ammonia are 193, 214, 222, 234 and 271 nm. Three or more of these wavelengths in combination break NH₃ into its components: N₂ (g) and H₂ (g) without producing ozone. Examples of wavelengths for dissociation include 193 nm and 214 nm, both of which are required. A wavelength of 248 nm will break down Ozone. In a preferred embodiment, the energy of dissociation source frequency range is from 115 nm to 400 nm, with appropriate filters, to satisfy the precise frequency of dissociation energies required for hydrogen dissociation only. Adjustments are made for cage effect and molecular interaction.

In one embodiment, the energy source frequency is supplied by a tunable laser or light energy source that subjects samples to a mono-energy.

If the proper dissociation bond energy at a sufficient intensity to dissociate a selected bond or group of bonds is applied, there are no indiscriminate or random molecules or atoms produced other than what will be determined by the selected bonds which are targeted for dissociation, eliminating the random production of undesirable by-products or intermediates seen in oxidation and reduction, microbial or indiscriminate chemical reaction. An electron sink can also be added to the process to insure that there is no recombination or potential for intermediate or by-product production.

C. Catalysts

In some embodiments, the anode includes a catalyst. The catalyst enhances the rate of bond dissociation. The catalyst can be any material of any physical configuration which is compatible with the sample and any other energy of dissociation sources. Catalysts may be unifunctional, multifunctional, or a combination thereof. Catalysts can be used alone or in combination with other catalysts. In certain embodiments, the catalyst is used to drive the reaction to approximately 100% completion (e.g., to dissociate essentially all of a target molecule.

The catalyst, when present, may be dissolved or dispersed within the feedstock, or supported on a surface within the anode. In some embodiments, a suitable catalyst is deposited on the surface of the electrode. In other embodiments, a suitable catalyst is deposited on a surface of an energy source, such as a fiber optic device. Catalysts may also be applied to the surface of a carrier, such as a nanoparticle, which is dispersed within the feedstock.

In a preferred embodiment, an energy source includes a photocatalyst and photonic (light-based) energy source. The photocatalyst provides an effective means for converting light into chemical energy. The catalyst or photocatalyst may be a semi-conductive material such as titanium oxides, platinized titania, amorphous manganese oxide, and copper-doped manganese oxide, titanium dioxide, strontium titanate, barium titanate, sodium titanate, cadmium sulfide, zirconium dioxide, and iron oxide. Photocatalysts can also be semiconductors that support a metal, such as platinum, palladium, rhodium, and ruthenium, strontium titanate, amorphous silicon, hydrogenated amorphous silicon, nitrogenated amorphous silicon, polycrystalline silicon, and germanium, and combinations thereof. Catalysts or photocatalysts can be nitrides; metal nitrides such as titanium nitride, molybdenum nitride, or iron nitride; nitrides of graphitic carbon; or combinations thereof. Catalysts or photocatalysts can be carbon-based graphene or graphite, fullerenes, as well as carbon-doped semi-conductive or other magnetic material, for example, graphene doped amorphous Manganese Oxide (AMO). The photocatalysts can be doped metal oxides where the dopants are distributed throughout the oxide to create an electric field within the anode to prevent recombination. The dopants can be distributed wherein the dopant density varies in a controlled manner across the metal oxide. In some embodiments the photocatalyst is the metal oxide bismuth vanadate (BiVO₄). The BiVO₄ can be doped to prevent recombination and enhance charge carrier generation. In some embodiments the BiVO₄ is doped with Tungsten atoms. The dope BiVO₄ can contain additional catalyst layers, for instance an inexpensive cobalt phosphate catalyst can also be employed for splitting water to make hydrogen gas.

Catalysts may be modified to increase or optimize activity. Some of the parameters to increase activity include enhanced surface area, optimization of [Cu²⁺], and resultant morphology. The electronic properties of the catalyst may also be important since the AMO is mixed valence (Mn²⁺, Mn³⁺, Mn⁴⁺) and possible reduction of Cu²⁺ to Cu¹⁺. The most active photocatalysts can be analyzed with X-ray photoelectron spectroscopy to study the oxidation state of the copper in these materials. Catalysts are characterized with X-ray powder diffraction (XRD) to study any crystallinity of the materials, electron diffraction (ED) in a transmission electron microscope (TEM) to study both crystalline and amorphous content of the catalyst, and atomic absorption (AA) for compositions of the catalyst. Semi-quantitative analyses of the solid sample can be done by energy dispersive X-ray analyses in a scanning electron microscope (SEM).

D. Electrodes

The anodes contain one or more electrodes. Electrodes preferably possess appropriate dimensions to facilitate contact with the feedstock. For example, the electrode can be positioned to traverse a fluid flow path between the fluid inlet and the fluid outlet. In some embodiments, the electrode is designed to have a high surface area, and to facilitate flow of a feedstock through the anode. For example, the electrode may be a wire mesh or similar structure.

Electrodes are fabricated from a conductive material that can accept electrons released by precise energy separation. The electrodes are electrically connected to an electron sink using suitable means to efficiently transfer electrons from the electrode to the electron sink. In some embodiments, the electrodes are metal oxides. In some cases it may be beneficial to use optically transparent electrodes which may include transparent conducting oxides such as indium-tin-oxides or aluminum-zinc-oxides. In some embodiments, the electrodes may be graphene or graphene oxides. In some cases, the electrodes may be common monatomic electrode materials such as aluminum, calcium, silver, gold, or palladium.

E. Electron Sinks

The electrode is electrically connected to an electron sink. The electron sink has an appropriate potential to cause electrons accepted by the electrode to flow to the electron sink.

In some embodiments, the electron sink is a cathode which performs a reduction half-cell reaction. In other embodiments, the electron sink may be a cathode within a battery. In these cases, the anode may serve to charge a battery. In other embodiments, the electron sink may be a piezoelectric material. In these cases, the direct electrical current collected at the anode can be converted into mechanical energy. The cathode may in some embodiments be a metal or metal oxide such as a nickel or nickel oxide material. The cathode may include titanium oxides (TiO₂), platinized titania, amorphous manganese oxide, copper-doped manganese, strontium titanate, barium titanate, sodium titanate, cadmium sulfide, zirconium dioxide, iron oxide, carbon-based graphene or graphite, fullerenes, buckyballs, diamond, combinations of carbon-doped semi-conductive materials, carbon-doped magnetic materials, graphene oxides, nickel, nickel molybdenum, boron nitride, semiconductor materials including platinum, palladium, rhodium, and ruthenium, strontium titanate, amorphous silicon, hydrogenated amorphous silicon, nitrogenated amorphous silicon, polycrystalline silicon, germanium, and combinations thereof.

### III. Fuel Cells Based Upon Precise Energy Dissociation

Fuel cells typically include an anode, a cathode, and an electrolyte that allows charges to move between the anode and cathode. During fuel cell operation, a chemical fuel is oxidized at the anode, producing positively charged ions and electrons. The electrolyte permits the cations produced at the anode to flow through the electrolyte to the cathode; however, the electrolyte does not facilitate the flow of electrons to the cathode. Rather, electrons are drawn from the anode to the cathode through an external circuit, producing direct current electricity.

Fuel cells are frequently classified by the type of electrolyte employed. For instance, the electrolyte can be a liquid, a solid oxide, or a polymer. Liquid electrolyte materials include potassium hydroxide solutions, phosphoric acid solutions, or molten alkali carbonates, typically enclosed in a solid matrix. In some embodiments, the electrolyte transports protons from the anode to the cathode region. In some embodiments, the electrolyte is a solid or semi-solid polymer membrane. In some embodiments, the electrolyte is a wire, preferably a polymer nanowire that connects the anode and cathode regions and facilitates the conduction of protons.

Proton exchange membrane (PEM) fuel cells, also known as polymer electrolyte membrane fuel cells, have attracted particular interest in recent years. PEM fuel cells contain an anode and a cathode separated by a proton-conducting membrane. During fuel cell operation, a chemical fuel (hydrogen gas) is delivered to the fuel cell anode. The hydrogen gas is oxidized at the anode (typically in the presence of a catalyst), and dissociates into protons and electrons. The newly formed protons permeate through the polymer electrolyte membrane to the cathode side of the fuel cell. The electrons travel along an external load circuit to the cathode side of the fuel cell, creating the current output of the fuel cell. Meanwhile, a stream of oxygen is delivered to the cathode. At the cathode side, oxygen molecules react with the protons permeating through the polymer electrolyte membrane and the electrons arriving through the external circuit to form water molecules. In this fashion, PEM fuel cells transform the chemical energy liberated during the electrochemical reaction of hydrogen and oxygen to electrical energy.

PEM fuel cells can be used to generate electrical power without producing pollutants and without consuming non-renewable hydrocarbon-based fuels, such as oil or gasoline. However, PEM fuel cells are hampered by several drawbacks. PEM fuel cells employ hydrogen gas as a chemical fuel. Hydrogen gas is difficult to store and transport to the anode surface. In addition, hydrogen cannot be produced in an economical fashion without the presence of impurities, such as carbon monoxide. These impurities can poison catalysts in the fuel cell, diminishing fuel cell performance over time. Many PEM fuel cells also employ expensive platinum catalysts, making PEM fuel cells too expensive for many applications. In addition, the efficiency of PEM fuel cells falls far short of their theoretical maximum performance.

Microbial fuel cells are similar to PEM fuel cells, except that the chemical reactions taking place in the anode region, cathode region, or both regions are promoted by microorganisms. As the microorganisms digest molecules in the feedstock, electrons and/or protons are generated and transferred through the electrode or the electrolyte materials respectively. Microbial fuel cells have the advantage that they can handle a larger variety of feedstock. Microbial fuel cells can, in principal, digest any form of organic material (glucose, acetate, wastewater, etc.) to produce electricity.

Fuel cells can be constructed which incorporate an anode that utilizes precise energy separation, as described above. In these embodiments, the electron sink is a cathode at which a reduction half-cell reaction occurs involving one or more of the component products formed at the anode. In certain embodiments, the fluid outlet of the anode is typically connected to a second container containing the cathode at which a reduction half-cell reaction involving one or more of the component products formed at the anode occurs. In these instances, a selectively permeable membrane, such as a proton exchange membrane, may be positioned between the anode and the cathode as required for fuel cell performance. The cathode may be similar to the PEM cathode, wherein a stream of oxygen is passed across the membrane and combines with the protons and the electrons coming through the electrode to form water. In some embodiments, the cathode region may incorporate microorganisms. In some embodiments, the anodes utilize PES to mimic microbial digestion processes.

A plurality of fuel cells based upon precise energy dissociation can be electrically connected in parallel, in series, or combinations thereof in order to form a fuel cell stack with the voltage and current output required for a particular application.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

I claim:

1. An anode comprising
a container configured to hold a feedstock comprising one or more target molecules,
an energy source that provides an effective amount, intensity, and frequency of energy to specifically dissociate one or more target bonds in the one or more target molecule in the feedstock, and
an electrode connected to an electron sink,
wherein the energy source is positioned to transfer the energy to the target molecules in the feedstock.

2. The anode of claim 1, wherein the energy is in the form of light irradiation, acoustic energy, or electromagnetic radiation.

3. The anode of claim 1, wherein the energy is amplified.

4. The anode of claim 1, wherein the energy is supplied by an energy source selected from the group consisting of frequency generators, electrical generators, plasma generators, arc lamps, pulse generators, amplifying generators, tunable lasers, ultraviolet lamps, ultraviolet lasers, pulse ultraviolet generators, ultrasound generators, and combinations thereof.

5. The anode of claim 1, wherein the energy source is a pulsed light source.

6. The anode of claim 1, further comprising a catalyst.

7. The anode of claim 6, wherein the catalyst is a semi-conductive material or magnetic material.

8. The anode of claim 6, where in the catalyst is selected from the group consisting of titanium oxides (TiO₂), platinized titania, amorphous manganese oxide, copper-doped manganese oxide, titanium dioxide, strontium titanate, barium titanate, sodium titanate, cadmium sulfide, zirconium dioxide, and iron oxide.

9. The anode of claim 6, wherein the catalyst is a semiconductor material selected from the group consisting of platinum, palladium, rhodium, and ruthenium, strontium titanate, amorphous silicon, hydrogenated amorphous silicon, nitrogenated amorphous silicon, polycrystalline silicon, germanium, and combinations thereof.

10. The anode of claim 6, wherein the catalyst is selected from the group consisting of carbon-based graphene or graphite, carbon-doped semi-conductive material, carbon-doped magnetic material, or fullerene materials.

11. The anode of claim 1, wherein the energy source is a fiber optic device.

12. The anode of claim 11, wherein the fiber optic device comprises a graphene coating.

13. The anode of claim 1, wherein the target molecules are selected from the group consisting of alkyl sulfonates, alkyl phenols, ammonia, benzoic acid, carbon monoxide, carbon dioxide, chlorofluorocarbons, dioxin, fumaric acid, grease, herbicides, hydrochloric acid, hydrogen cyanide, hydrogen sulfide, formaldehyde, medicines, methane, nitric acid, nitrogen dioxide, nitrates, nitrites, ozone, pesticides, polychlorinated biphenyls, oil, sulfur dioxide, sulfuric acid and volatile organic compounds.

14. The anode of claim 1, wherein the target molecules comprise waste material.

15. The anode of claim 14, wherein the waste material is selected from the group consisting of ventilation makeup air, ambient air, air from stripping and off-gassing operations, soil vapor extraction (SVE), airborne matter, organic particulate matter, process vent gas, wastewater treatment off-gas, liquid effluents, wastewater, industrial runoff, agricultural runoff, polluted soil, sludge waste, and landfill waste.

16. The anode of claim 1, wherein the electron sink is selected from the group consisting of a cathode which performs a reduction half-cell reaction, a cathode within a battery, a piezoelectric material, and combinations thereof.

17. A fuel cell comprising the anode of any one of claims 1-16 and a cathode.

18. The fuel cell of claim 17 wherein the cathode comprises platinum, platinum chromium, graphene, graphene oxide, titanium, platinized titania, or a combination thereof.

19. The fuel cell of claim 17 or claim 18 further comprising one or more semipermeable membranes.
